(19) United States
(12) Patent Application Publication
(10) Pub. No.: US 2006/0053411 A1
(43) Pub. Date: Mar. 9, 2006

(54) SYSTEMS, METHODS, AND COMPUTER READABLE MEDIA FOR CONSISTENTLY RENDERING USER INTERFACE COMPONENTS

(75) Inventor: Masaaki Takamiya, Cary, NC (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: IBM CORPORATION, Armonk, NY (US)

(21) Appl. No.: 10/711,296

(22) Filed: Sep. 9, 2004

(51) Int. Cl. G06F 9/44; G06F 17/21

(52) U.S. Cl. 717/115; 715/513

(57) ABSTRACT

A system, method, and computer readable medium are provided for consistently rendering graphical user interface (GUI) components from disparate web server delivery mechanisms. To this end, a Javascript script is downloaded with a web page and, when executed, accesses a style sheet which is typically used when displaying HTML. From the style sheet, the Javascript script retrieves GUI information describing the look and feel of the user interface components composing the web page. Utilizing an application programming interface (API), a downloaded Java® applet retrieves the GUI information from the Javascript script. The Java® applet utilizes the retrieved GUI information to render subsequent GUI screens.

### FIELD OF THE INVENTION

The present invention generally relates to systems, methods, and computer readable media for presenting graphical user interfaces (GUIs), and more particularly, to advantageous systems, methods, and computer program products for consistently rendering graphical user interface (GUI) components from disparate web server delivery mechanisms.

### BACKGROUND OF THE INVENTION

With the increase in the popularity of the “World Wide Web” (WWW), the use of web browsers or browsers has become more common. For example, a web browser available from Netscape, Inc., known as Netscape Navigator®, can provide a convenient way to operate applications and view data via the web. Some of the applications available via the web can provide a high level of interaction with the user as these applications may be written in native languages such as C or Java® or interpretive languages such as JavaScript®. In particular, applications written in these types of languages can be specifically written to require intensive user interaction. As the level of interaction between the user and the application increases, so does the importance of a consistent user interface provided by the application hosted on a web server.

In today's web server environment, many alternatives are provided for an application provided by a web server to interact with a user at a client machine. One alternative may include downloading a Java® applet from a web server to a client. The Java® applet typically includes library calls from the lava 2 Platform, Enterprise Edition (J2EE) software development toolkit (SDK). The Java® applet would contain computer instructions written in the Java® language which would be executed by a Java® virtual machine (JVM) resident on the client machine to interact with a user of the client machine. Executing such computer instructions on the client machine lowers the capacity requirements of a web server and the bandwidth to communicate the results of those instructions from the web server to the client. When a Java® applet renders user interface screens on a client machine, it typically calls a class named LookAndFeel to make each user interface screen rendered by the Java® applet consistent with other user interface screens generated by the same Java® applet. Utilizing the LookAndFeel class, for example, a Java® applet may readily set the foreground, background, and font properties for each screen the Java® applet renders to the user.

Another alternative for interacting with a user at a client machine in the web server environment includes the use of a portal. The portal can allow a user to access multiple applications through a single screen displayed by the web browser. For example, some portals allow users to access applications that can show disparate data, such as weather, sports, stock information, or the like, to a user on a single screen. Each of the disparate types of data is typically controlled by a portlet. A portlet is computer code which adheres to interfaces and behaviors specified in a portlet specification and executes in a portal application server. Examples of a portlet specification include IBM's portlet API and Java® Standardization Request for the Java Portlet Specification defined by the Java Community Process.

In the portal environment, a portal aggregates hypertext markup language (HTML) documents which are transmitted from the web server to a client machine. A web browser on the client machine then renders these HTML documents for display. Consistent user interface screens may be achieved between HTML documents by having each HTML document reference the same style sheet when rendering user interface elements. A style sheet such as a cascading style sheet (CSS) specifies the presentation of each user interface component found in each HTML document. For example, a style sheet may contain a description of the font for text appearing in a graphical button or the background color of a rendered portlet. For more information concerning cascading style sheets, refer to The HTML Writers Guild web site found on the Internet.

In short, a Java® applet typically requires instantiation of a LookAndFeel class to make consistent the presentation of each screen rendered by the Java® applet. HTML page generators such as portals, portlets, java® server pages (JSPs), servlets, and the like typically utilize style sheets to make consistent the presentation of each screen rendered by a web browser. These two approaches are mutually exclusive because popular versions of the J2EE SDK do not utilities to access style sheets from a Java® applet.

### SUMMARY OF THE INVENTION

Among its several aspects, due to the mutually exclusive alternative approaches for achieving a consistent screen presentation in a web server environment, the present invention recognizes that a need exists for providing a mechanism for achieving consistent user interface screens regardless of the means for delivering information to a user in a web server environment. The present invention also recognizes that methods, systems, and computer program products are needed to provide a consistent user interface when a Java® applet is included in a downloaded web page. Further, the present invention recognizes the value of providing a technique to establish a consistent user interface from two disparate techniques.

The present invention advantageously provides techniques for obtaining both the benefits of utilizing a Java® applet, as well as, the benefits obtained by presenting an HTML page through a web browser. Since a Java® applet is a software application which executes on a client, the power requirements of a server are reduced. Also, a Java® applet is written in a programming language which is rich in functionality. Thus, the Java® applet may provide more advanced user interfaces than those described in HTML. On the other hand, HTML pages utilize well known style sheets which provide style information allowing consistent user interfaces between rendered HTML pages. Further, since HTML pages are typically rendered by a web browser, no additional software needs to be downloaded to a client when rendering an HTML page. By providing techniques whereby both a Java® applet and HTML pages can be utilized together, the present invention provides for development of applications which are seamless from the point of view of their user interface and which achieve the benefits of both Java applets and HTML pages.

One aspect of the present invention includes a technique embodied in a Javascript script modified in accordance with the teachings of the present invention. The Javascript script is downloaded with a web page and, when executed, accesses a style sheet. From the style sheet, the Javascript script retrieves GUI information describing the look and feel of the user interface components composing the web page. Utilizing a known application programming interface (API), a downloaded Java® applet modified in accordance with the teachings of the present invention retrieves the GUI information from the Javascript script. The Java® applet utilizes the retrieved GUI information to render subsequent GUI screens.

A more complete understanding of the present invention, as well as further features and advantages of the invention, will be apparent from the following Detailed Description and the accompanying drawings.

### BRIEF DESCRIPTION OF THE DRAWINGS

FIG. 1 is an illustration of an exemplary web server environment in which the present invention may be suitably implemented.

FIG. 2A is a screen shot of an exemplary menu screen rendered by a portal in accordance with the present invention.

FIG. 2B is a screen shot of an exemplary menu screen rendered by a Java® applet without the present invention.

FIG. 2C is a screen shot of an exemplary menu screen rendered by a Java® applet in accordance with the present invention.

FIG. 3 is a block diagram illustrating a client/server system in accordance with the present invention.

FIG. 4 is a flow diagram illustrating the flow of information between a client machine and a server machine in accordance with the present invention.

FIG. 5 is a flow chart illustrating a method of providing a consistent look and feel in a GUI generated by a Java® applet modified in accordance with the teachings of the present invention and a GUI generated by a web browser rendering an HTML page in accordance with the present invention.

### DETAILED DESCRIPTION

The present invention will now be described more fully with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

As will be appreciated by one of skill in the art, the present invention may be embodied as methods, systems, or computer program products. Accordingly, the present invention may take the form of a hardware embodiment, a software embodiment or an embodiment combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, flash memories, or magnetic storage devices.

Computer program code or “code” for carrying out operations according to the present invention may be written in an object oriented programming language such as JAVA®, JavaScript®, Visual Basic®, or in various other programming languages. Software embodiments of the present invention do not depend on implementation with a particular programming language. Portions of the code may execute entirely on one or more systems utilized by an intermediary server.

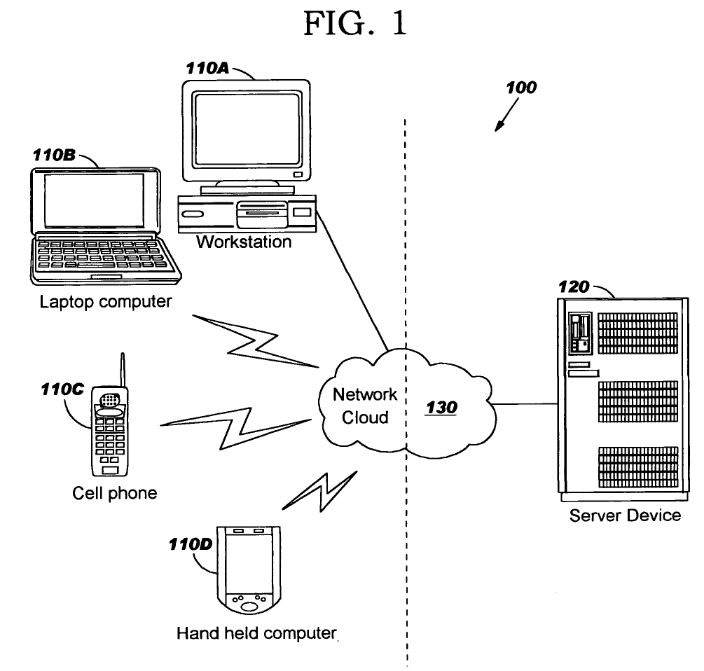

The code may execute entirely on one or more servers, or it may execute partly on a server and partly on a client within a client device or as a proxy server at an intermediate point in a communications network. Regarding the former scenario, FIG. 1 is an illustration of an exemplary system 100 in which the present invention may be suitably employed. The system 100 includes a client device modified according to the teachings of the present invention, such as a workstation 110A, a laptop computer 110B, a cell phone 110C, a handheld computer 110D, or any other computer based device which can execute computer program code. The client device may be connected to a server 120 modified according to the teachings of the present invention over network 130 such as a LAN, WAN or other intranet, or the connection may be made through the Internet via an Internet service provider (ISP). It is understood that the present invention is not TCP/IP specific or Internet specific. The present invention may be embodied using various transport and data link protocols over various types of computer networks.

Embodiments according to the present invention can operate in a logically separated client side/server side computing environment, sometimes referred to hereinafter as a client/server environment. The client/server environment is a computational architecture that involves a client process or client, a server process or server, and the client requesting service from a server. In general, the client/server environment maintains a distinction between processes, although client and server processes may operate on different machines or on the same machine. Accordingly, the client and server sides of the client/server environment are referred to as being logically separated as shown in FIG. 1. Usually, when client and server processes operate on separate devices, each device can be customized for the needs of the respective process. For example, a server process can execute on a system having large amounts of memory and disk space, whereas the client process often executes on a system having a graphic user interface (GUI) provided by high end video cards and large screen displays.

A client may include a program, such as a web browser, that requests information, such as web pages or portlet views, from a server. Examples of clients include browsers such as Netscape Navigator® and Internet Explorer®. Browsers typically provide a graphical user interface for retrieving and viewing web pages, web portals, portlets, applications, and other resources served by web servers.

A server may include a program that responds to requests from the client. Some examples of servers are International Business Machines Corporation's (IBM) family of Lotus Domino® servers, IBM's Websphere® servers, the Apache server, and other suitable servers.

The clients and servers can communicate using a standard communications mode, such as hypertext transport protocol (HTTP). According to the HTTP request/response communications model, HTTP requests are sent from the client to the server and HTTP responses are sent from the server to the client in response to an HTTP request. In operation, the server waits for a client to open a connection and to request information, such as a web page, portlet, or other like information. In response, the server sends a copy of the requested information to the client, closes the connection to the client, and waits for the next connection. It will be understood that the server can respond to requests from more than one client.

The present invention is described below with reference to block diagrams and flowcharts which illustrate various aspects of methods, systems and computer program products according to embodiments of the present invention. It is understood that each block of the block diagrams and flowchart illustrations, and combinations of blocks in the block diagrams and a flowchart illustration, can be implemented by computer program code. The computer program code may be provided to a processor of a general purpose computer, special purpose computer, or other programmable data processing apparatus to produce a machine, such that code, which executes via the processor of the computer or other programmable data processing apparatus, creates means for implementing the functions specified in the block diagrams and/or flowchart block or blocks.

Computer program code or instructions may be stored in a computer readable memory that can direct a computer or other programmable data processing apparatus to function in a particular manner, such that the instructions stored in the computer readable memory produce an article of manufacture including instruction means which implement the function specified in the block diagrams or flowcharts.

The computer program code may be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagrams and/or flowchart block or blocks.

As used herein, the term “web site” can include a related collection of files that includes a beginning file called a home page. From the home page, a visitor can access other files and applications at the web site. A large web site may utilize a number of servers, which may or may not be different, and may or may not be geographically dispersed. For example, the web site of the International Business Machines Corporation consists of thousands of web pages and files dispersed over multiple web servers in locations worldwide.

As is known to those skilled in the art, a web page is conventionally formatted via a standard page description language such as HTML, which typically contains text and can reference graphics, sound, animation, and video data. HTML provides for basic document formatting and allows a web content provider to specify anchors or hypertext links, typically manifested as highlighted text, to other servers. When a user selects or activates a particular hypertext link, a browser running on the user's client device reads and interprets an address, called a uniform resource locator (URL) associated with the hypertext link, connects the browser with a web server at that address, and makes a request such as an HTTP request for the file identified in the hypertext link. The web server then sends the requested file to the client which interprets and renders the web page for display. The term “user” as used herein can be a software process or a human being.

A web browser can be used to view what is sometimes referred to as a web portal or portal. As understood by those skilled in the art, web portals can operate according to the same communication protocols described above in reference to clients and servers where the client includes a web browser that views portal pages or portal views and the server is sometimes referred to as a portal applications server that serves requested information to the web browser.

A portal may cause display of a single presentation or view of information from multiple sources, sometimes referred to as an aggregation of information. Portals often include information such as calendars and to do lists, discussion groups, announcements and reports, news, stock quotes, searches, email and address books, weather, maps, shopping, and the like, all of which may be provided to the portal by different sources or applications.

Much of the information provided by the portal can be customized by the user. For example, some portals, such as, My Lycos®, can be customized to display the weather forecast in a user's area or display sports scores for the user's favorite teams. Moreover, the customization can include the look and feel of a portal itself. For example, some portals can be customized to be displayed using particular screen themes.

Portlets are Java® based web components executed on a server which process requests and generate dynamic content. Portals use portlets as pluggable user interface components that provide a presentation layer to information systems. Portlet views correspond to the visible active components a user of the portal sees within the portal page. Similar to a window in a desktop computer, each portlet view is allocated a portion of the client screen within the portal view where the relevant information is displayed. The portlet generates content to be embedded into portal pages viewed by the user. A portlet itself may have many portlet views where each view represents a particular state of the portlet. A portlet may interact with data typically managed at a server to lead to a transaction with a user. Each portlet view may correspond to a different state of the transaction. For example, through a portlet, a user may sell stock. One portlet view may represent the user's brokerage account status displaying the different stocks in which the user has a position. The portlet which controls the transaction may transition the first portlet view to a second portlet view when the user clicks on one of his stocks in his portfolio. The second portlet view would represent the view that the user enters the number of shares to sell and the minimum sales price acceptable by the user. A portlet view may be developed by any technology which separates content generation from a user interface such as Sun Microsystem's Java® Server Pages technology.

Although the present invention is described herein with reference to portals and portlets as web entities which generate HTML documents and utilize style sheets to maintain consistent user interfaces between rendered HTML documents, it will be understood that the present invention can be practiced with any web entity which generates HTML documents and utilizes style sheets such as Java® Server Pages (JSPs), for example.

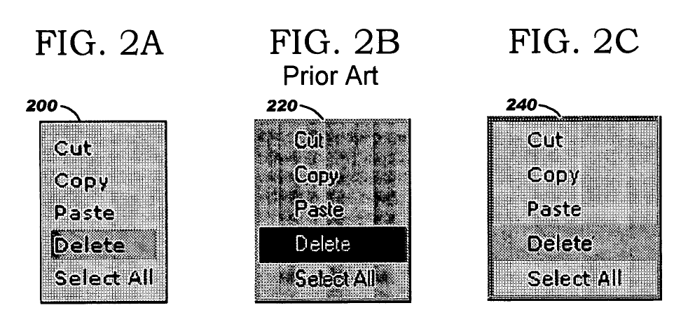

FIG. 2A is a screen shot of an exemplary menu screen 200 rendered by a portal in accordance with the present invention. In creating the menu screen 200, the portal generates HTML code to display the menu screen and utilizes a style sheet to define the user interface components contained in the HTML. The menu screen 200 is the base to which FIGS. 2B and 2C are compared. FIG. 2B is a screen shot of an exemplary menu screen 220 rendered by a Java® applet without the present invention while FIG. 2C is a screen shot of an exemplary menu screen 240 rendered by a Java® applet modified in accordance with the teachings of the present invention. Because the Java® applet used to render FIG. 2B does not have access to the style sheet, the font type and size of the displayed words and the menu's background are all determined by the programmer of the Java® applet without knowledge of the style sheet.

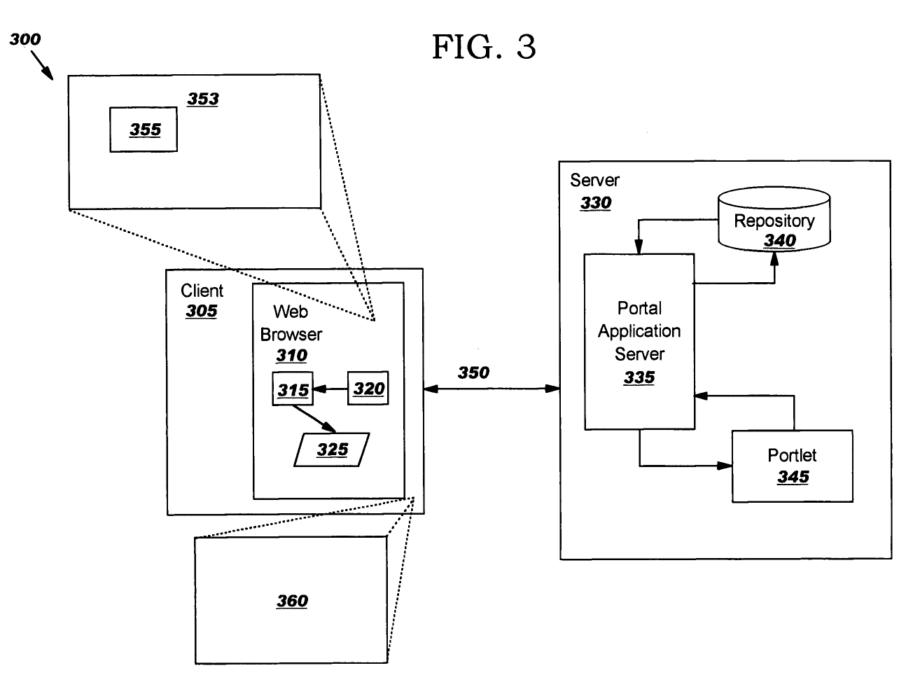

When comparing menu screen 220 with menu screen 200, several differences are evident. The highlighting of a selection, for example, selecting “Delete” is darker than the highlight of selecting “Delete” in FIG. 2A. The font types and the menu background are also different. However, when comparing menu screen 240 with menu screen 200, the font type and size, highlighted selection and menu background are all similar. Menu screen 240 was rendered by a Java® applet modified in accordance with the present invention. Thus, the Java® applet modified in accordance with the present invention has access to the style sheet used in rendering menu screen 200. The manner in which the Java® applet gains access to the style sheet is described in connection with the discussion of FIG. 3 below. It is noted that although a menu screen is used to illustrate the similarities achieved by the present invention, the present invention is applicable to all user interface properties which are renderable to a screen.

By achieving the same look and feel between rendering a user interface through HTML as generated by a portal and rendering a user interface through a Java® applet, the present invention advantageously provides a user with the ability to connect user interfaces generated by a portal and user interfaces generated by a Java® applet with each other. This approach advantageously provides application developers with the tools to combine the advantages of both portals and java applets when developing a seamless overall web application.

FIG. 3 is a block diagram illustrating an exemplary client/server system 300 having a client 305 and a server 330 in accordance with the present invention. According to FIG. 3, a client 305 communicates with a server 330 on a server side in a logically separated client side/server side computing environment over a communication channel 350.

The client 305 includes a web browser 310, program code 315 and 320, and memory 325 to store style sheet information. Program code 315, modified in accordance with the teachings of the present invention, executes computer instructions written in a script language. Preferably, the computer instructions are written in JavaScript® and act as a conduit for allowing a Java® applet to access style sheet information. Program code 320, modified in accordance with the teachings of the present invention, executes computer instructions written as a Java® applet. The style sheet data 325 may be stored in local or remote memory. As described below, it should be noted that the Javascript®, Java® applet and style sheet information are typically stored at a server and downloaded to the client 305.

The server 330, such as IBM's Websphere® server modified according to the teachings of the present invention, includes a portal application server 335, a portlet 345 and a repository 340. The portal application server 335 provides a container for deploying the portlet 345. The repository 340 stores style sheet data such as a cascading style sheet for providing a template of the user interface components of an HTML document. It should be noted that the repository 340 may represent a storage medium such as memory, a tape drive, a disk drive, and the like. Further, the repository may optionally exist internal to the server or external to the server but accessible by the server.

In operation, a user would invoke the web browser 310 to establish a session with a portal application server 335 in order to request information through the portal application server 335. The portal application server 335 authenticates the user and responds to the request for information by accessing style sheet information from the repository 340 that can be associated with the user of a portal view 353. The portal view 353 may be interpreted as the displayable content generated by the portal application server 335. The style sheet information retrieved from the repository 340 can also include information for customizing a particular portlet view 355 or portal view 353. The portlet view 355 may be interpreted as displayable content generated by the portlet 345. For example, style information for the portal and portlet views can include a type of skin or screen information associated with how the portal and portlet are to appear in the portal view corresponding to portal view 353. Furthermore, the style information can include information associated with appearance of graphical user elements such as pull down menus, text boxes, radio buttons, and the like.

The portal application server 335 also accesses a computer program or portlet code 345 for each portlet view which will be delivered to the web browser 310 on the client side. However, it is noted that one portlet may generate multiple portlet views such that a one-to-many relationship may exist between a portlet and its generated portlet views. The portlet code 345 generates portlet information such as content consumable by a user. The portlet code 345 preferably provides the portlet information in the form of HTML to portal application server 335. The portlet code 345 in the presently described example generates HTML which imbeds references to both a script 315 and a Java® applet 320 which is modified in accordance with the present invention as described below. Alternatively, the script 315 may be completely imbedded in the generated HTML. The portal application server 335 aggregates HTML tags obtained from portlet 345 and other optional portlets into a single HTML file and associates the HTML file with style sheet information.

The portal application server 335 sends the HTML file and the style sheet information to the client 305. The web browser 310 processes the HTML file and temporarily stores the style sheet information into memory 325. In processing the HTML file, the portlet view 355 corresponding to the portlet information generated by portlet 345 is displayed in web browser 310. Further processing the HTML file, the script 315 and Java® applet 320, as modified by the teachings of the present invention, are retrieved by the web browser 310. The script 315 and Java® applet 320 may be retrieved from server 330 or another accessible server. Once the script 315 and Java® applet 320 are retrieved, the client 305 utilizes a java plug-in to execute the Java® applet 320. During the initialization of a graphical user interface code, the Java® applet 320, as modified according to the teachings of the present invention, calls a predefined function of the script 315 using a known Javascript-Applet communication application programming interface (API) such as Netscape's LiveConnect® package. The following code segment is an exemplary set of instructions in the Java® applet 320 according to the present invention used to invoke the predefined function called retrieveStyles. The screen background, menu background, and menu foreground colors are extracted from the string returned by the retrieveStyles function call. After the string s is returned from the retrieveStyles function call, each color is extracted from the string and converted into a Color object.

private void retrievePortalDefaults( ) {

try{

netscape.javascript.JSObject browserWindow

= netsca pe.javascript.JSObject.getWindow(env.

getApplet( ));

String s = (String)browserWindow.eval(“retrieve
Styles( )”);
java.util.StringTokenizer tokens = new java.util.String

Tokenizer(s,“™”);

menuBackground =

getColorFromHexString(tokens.nextToken( ));

menuForeground = getColorFromHexString(tokens.
nextToken( ));
menuSelectionBackground = getColorFromHexString(tokens.
nextToken( ));
menuSelectionForeground = getColorFromHexString(tokens.
nextToken( ));

} catch (Exception e) {

System.out.printin(e);

}

}
private Color getColorFromHexString(String s) {

return new Color(Integer.val valueOf(s, HEXADECIMAL).
intValue( ));

}

The script 315, modified according to the teachings of the present invention, retrieves style sheet information from memory 325 and constructs a string detailing the style sheet information. The script 315 returns the string to the Java® applet 320. The Java® applet 320, according to the teachings of the present invention, parses the string according to a predefined organization to extract individual settings of graphical elements. The following code segment is an exemplary predefined set of script instructions written in JavaScript®. When executed, the code segment retrieves three colors from a style sheet file which are used for the background of a screen and the background and foreground of a menu in the screen. The code segment also returns a string containing the retrieved colors demarcated by a “|”.

function retrieveStyles( ) {

var menuBackground,

menuForeground,
menuSelectionBackground,
menuSelectionForeground;

var styleSheet, rules;
var styleSheets = document.styleSheets;
for (var i = 0; i < styleSheets.length; ++i) {

var href = styleSheets[i].href;
if (href.indexOf(′/Styles.css′) != −1) {

styleSheet = styleSheets[i];
rules = styleSheet.rules;
if (rules == null)

rules = styleSheet.cssRules;

break;

}

}
if (rules == null)

return null;

for (var i = 0; i < rules.length; ++i) {

var s = rules[i].selectorText;
if (s == ′.portlet-menu-item′) {

menu Background = rules[i].style.backgroundColor;
menu Foreground = rules[i].style.color;

} else if (s == ′.portlet-menu-item-selected′) {

menuSelectionBackground = rules[i].style.background
Color; menuSelectionForeground = rules[i].style.color;

}

}
return menuBackground + ‘|’ + menuForeground + ‘I’ +
menuSelectionBackground

+ ‘|’ + menuSelectionForeground;

}

As shown below, the Java® applet 320, according to the teachings of the present invention, initiates a new instance of a class such as the Java® 2 Enterprise Edition (J2EE) look and feel class based on the parsed information. When the exemplary PortalLookAndFeel class is instantiated as a PortalLookAndFeel object, the PortalLookAndFeel object's constructor initializes by calling the method initComponentDefaults method defined in the parent class javax.swing.plaf.basic.BasicLookAndFeel. The initComponentDefaults method uses the Color objects for setting the UIDefaults object. The UIDefaults object contains the values for the screen background, menu background, and menu foreground colors.

public class PortalLookAndFeel extends

javax.swing.plaf.basic.BasicLookAnd Feel {

protected void initComponentDefaults(UIDefaults table) {

super.initComponentDefaults(table);
retrievePortal Defaults( );
Object[ ] defaults =

{

“Menu.background”, menuBackground,
“Menu.foreground”, menuForeground,
“MenuBar.background”, menuBackground,
“MenuBar.foreground”, menuForeground,
“MenuItem.background”, menuBackground,
“MenuItem.foreground”, menuForeground,
“control”, background,

};
table.putDefaults(defaults);

}

Upon completion of the initialization of graphical user interface code, the Java® applet 320, according to the teachings of the present invention, displays the graphical user interface 360 with the same look and feel as the presented portlet view 355.

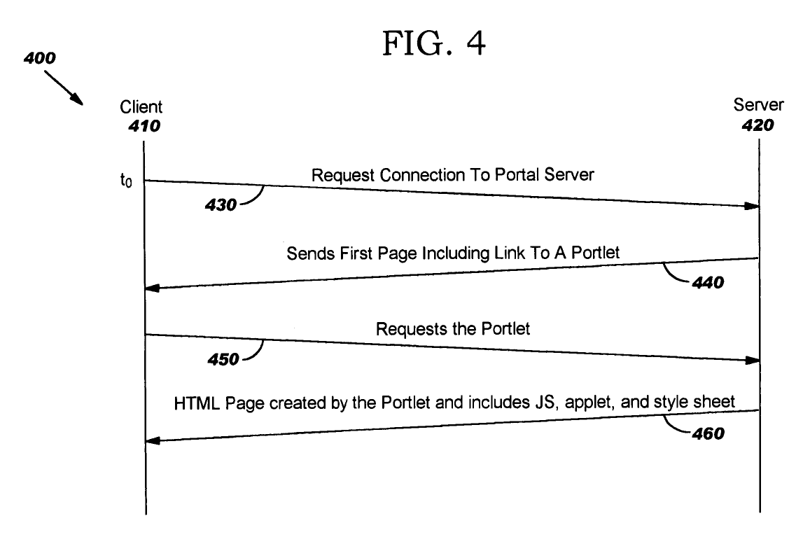

FIG. 4 is a flow diagram 400 illustrating the exemplary flow of information between a client 410 and a server 420 over communication channel 350 in FIG. 3 in accordance with the present invention. At time to, in response to a user initiating access to a server, the client 410 issues a request to connect 430 to a portal server resident on server 420. The server 420 composes a first HTML page 440 containing a link such as a uniform resource location (URL) to a portlet. Upon receipt of the first HTML page 440, the client 410 renders the first HTML page to a user. The user subsequently invokes the link displayed in the first HTML page. In response to the invocation of the link, the client 410 requests portlet information corresponding to the portlet. The server 420 sends portlet information, a script, a style sheet, and a Java® applet to client 410 in message 460. It should be noted that both the script and the Java® applet are modified according to the teachings of the present invention. It should be noted that references to a location for the client to subsequently locate the script, the Java® applet, or style may be provided in message 460.

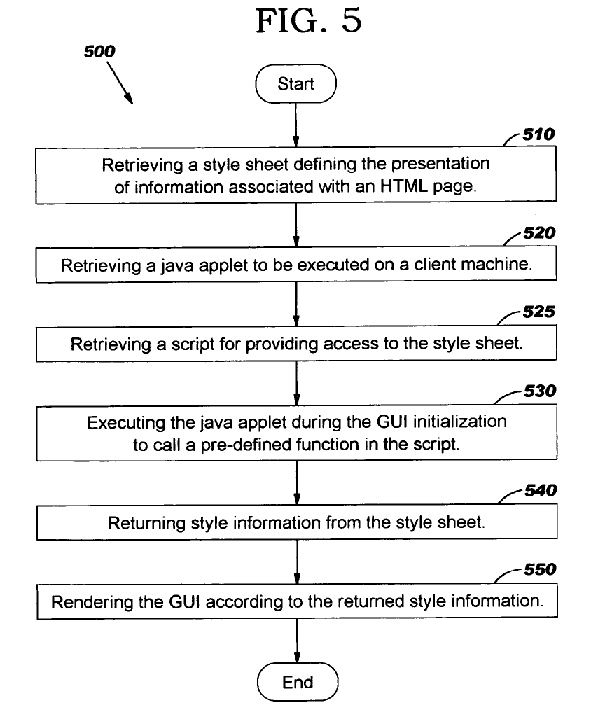

FIG. 5 is a flow chart illustrating a method 500 of providing a consistent look and feel in a GUI generated by a Java® applet modified according to the teachings of the present invention and a GUI generated by a web browser rendering an HTML page in accordance with the present invention. Typically, the steps of method 500 are executed by a client such as client 305. As shown in FIG. 5, operations can begin at step 510 by retrieving a style sheet defining the presentation of information associated with an HTML page. It should be noted that steps 510, 520, and 525 may be performed in any order. At step 520, the method retrieves a Java® applet modified according to the teachings of the present invention. At step 525, the method retrieves a conduit script modified according to the teachings of the present invention.

Proceeding to step 530, the method executes the Java® applet. During GUI initialization, the Java® applet calls a predefined function in the conduit script. At step 540, the conduit script is executed to return style information from the style sheet. At step 550, the Java® applet renders the GUI according to the returned style information.

While the present invention has been disclosed in the context of various aspects of presently preferred portal and portlet embodiments, it will be recognized that the invention may be suitably applied to other environments consistent with the claims which follow. Such environments include web server applications involving servlets, enterprise java beans, JSPs, and the like.

What is claimed is:

1. A system for software instructions to display a user interface according to user interface properties carried in a style sheet, the system comprising:
a means for retrieving the style sheet having user interface properties;
a means for retrieving software instructions to be executed on a client machine;
a means for retrieving a script for providing said software instructions access to the style sheet; and
a means for executing said software instructions on the client machine, said software instructions calling the script to retrieve user interface properties, said software instructions, when executed, displaying a user interface screen in accordance with the retrieved user interface properties.

2. The system of claim 1 wherein the software instructions are disposed in a Java applet.

3. The system of claim 1 wherein the script is a Javascript.

4. The system of claim 3 wherein the Java applet utilizes a Java-Javascript API to call the Javascript.

5. The system of claim 1 further comprising:
a portal application server for delivering the style sheet, the script, and the software instructions.

6. The system of claim 5 wherein the portal application server generates HTML having user interface components and associates the generated HTML with the style sheet, the system further comprising:
a browser for displaying the user interface components according to the style sheet.

7. A method for software instructions to display a user interface according to user interface properties carried in a style sheet, the method comprising:
retrieving the style sheet having user interface properties;
retrieving software instructions to be executed on a client machine;
retrieving a script for providing said software instructions access to the style sheet; and
executing said software instructions on the client machine, said software instructions calling the script to retrieve user interface properties, said software instructions, when executed, displaying a user interface screen in accordance with the retrieved user interface properties.

8. The method of claim 7 wherein the software instructions are disposed in a Java applet.

9. The method of claim 7 wherein the script is a Javascript.

10. The method of claim 9 wherein the Java applet utilizes a Java-Javascript API to call the Javascript.

11. The method of claim 7 further comprising:
delivering the style sheet, the script, and the software instructions from a portal application server.

12. The method of claim 11 wherein the portal application server generates HTML having user interface components and associates the generated HTML with the style sheet, the method further comprising:
displaying the user interface components according to the style sheet.

13. A computer readable medium whose contents cause a computer system to display a user interface according to user interface properties carried in a style sheet, the computer system performing the steps of:
retrieving the style sheet having user interface properties;
retrieving software instructions to be executed;
retrieving a script for providing said software instructions access to the style sheet; and
executing said software instructions, said software instructions calling the script to retrieve user interface properties, said software instructions, when executed, displaying a user interface screen in accordance with the retrieved user interface properties.

14. The computer readable medium of claim 13 wherein the software instructions are disposed in a Java applet.

15. The computer readable medium of claim 13 wherein the script is a Javascript.

16. The computer readable medium of claim 15 wherein the Java applet utilizes a Java-Javascript API to call the Javascript.

17. The computer readable medium of claim 13 further comprising:
delivering the style sheet, the script, and the software instructions from a portal application server.

18. The computer readable medium of claim 17 wherein the portal application server generates HTML having user interface components and associates the generated HTML with the style sheet, the computer readable medium further comprising:
displaying the user interface components according to the style sheet.
